(19) United States
(12) Patent Application Publication
(10) Pub. No.: US 2020/0198260 A1
(43) Pub. Date: Jun. 25, 2020

(54) PRESSURE VESSEL AND MANUFACTURING METHOD THEREOF

(71) Applicant: HONDA MOTOR CO., LTD., Tokyo (JP)

(72) Inventors: Koei FUJIKI, Wako-shi (JP); Masanori TOTSUKA, Wako-shi (JP); Yoshikazu SHINNABE, Wako-shi (JP); Yohei NOJI, Wako-shi (JP)

(21) Appl. No.: 16/718,857

(22) Filed: Dec. 18, 2019

(30) Foreign Application Priority Data
Dec. 20, 2018 (JP) 2018237889

(51) Int. Cl. B29C 70/32; F17C 1/00

(52) U.S. Cl. CPC B29C 70/32; B29K 2063/00; F17C 1/00

(57) ABSTRACT

In a pressure vessel formed by a fiber reinforced resin including reinforcing fibers and thermosetting resin impregnated in the reinforcing fibers, the fiber reinforced resin contains nylon particles dispersed in the thermosetting resin. Also disclosed is a method of manufacturing a pressure vessel including dispersing nylon particles in molten thermosetting resin, impregnating reinforcing fibers with the molten thermosetting resin having the nylon particles dispersed therein, wrapping the reinforcing fibers impregnated with the molten thermosetting resin around a mandrel, heating the reinforcing fibers and the thermosetting resin to cure the thermosetting resin, and removing the mandrel from the thermosetting resin after curing the thermosetting resin.

### TECHNICAL FIELD

The present invention relates to a pressure vessel and a method of manufacturing the same.

### BACKGROUND ART

Hydrogen tanks made of fiber reinforced resin for automotive use are known in the art. See JP2009-120627A and JP2007-162830A, for instance. A hydrogen tank made of fiber reinforced resin is advantageous in terms of weight compared to a metal hydrogen tank. However, thermosetting resins such as epoxy and phenol used as the matrix resin for the fiber reinforced resin are known to have low hydrogen gas barrier properties. Therefore, it has been a common practice to place a hydrogen barrier layer between fiber reinforced resin layers, to place a liner made of material having a high hydrogen gas barrier property on the inner surface of the fiber reinforced resin, or to coat a material having a high hydrogen gas barrier property on the outer surface of the fiber reinforced resin.

However, providing a hydrogen gas barrier on the inner surface, on the outer surface, or between adjoining layers in the wall of the pressure vessel complicates the manufacturing process, and increases both the material cost and the labor cost.

### SUMMARY OF THE INVENTION

In view of such a problem of the prior art, a primary object of the present invention is to provide a pressure vessel for storing pressurized gas such as hydrogen gas, CNG (compressed natural gas) and LPG (liquefied petroleum gas) that has a high gas barrier property and is simple in structure.

A second object of the present invention is to provide a method for manufacturing such a pressure vessel which is simple and efficient.

To achieve such an object, one embodiment of the present invention provides a pressure vessel formed by a fiber reinforced resin (10) including reinforcing fibers (12) and thermosetting resin (11) impregnated in the reinforcing fibers, wherein the fiber reinforced resin comprises nylon particles (15) dispersed in the thermosetting resin.

By thus dispersing particles of nylon which has a high gas barrier property against hydrogen gas, CNG, and LPG, the gas barrier property of the pressure vessel can be improved. The nylon particles can be dispersed in the thermosetting resin by mixing the nylon particles with the thermosetting resin before curing. Therefore, the gas barrier property of the pressure vessel can be improved without complicating the structure of the pressure vessel.

Preferably, the nylon particles have a diameter of 5 μm to 30 μm.

The wall of the pressure vessel typically includes reinforcing fiber layers largely consisting of reinforcing fibers and matrix layers largely consisting of resin matrix that are layered in an alternating manner. By properly selecting the particle size of the nylon particles, the nylon particles can be uniformly dispersed in the matrix layer. By thus forming a matrix layer containing an adequate amount of nylon particles, the required gas barrier property can be achieved. If the diameter of the nylon particles is smaller than 5 μm, the size of the nylon particles is so small as compared to the diameter of the reinforcing fibers, which are typically in the order 5 to 10 μm, that the nylon particles tend to be dispersed between the reinforcing fibers. As a result, the content of nylon particles in the matrix layer decreases.

Preferably, the nylon particles are contained in the thermosetting resin by 2 to 20 weight %.

Thereby, the pressure vessel may be given with an adequate gas barrier property without impairing the moldability of the thermosetting resin. If the content of the nylon particles is greater than 20 weight %, the viscosity of the thermosetting resin containing the nylon particles increases to such an extent that the moldability of the thermosetting resin may be impaired, and voids and other faults are more likely to be created in the thermosetting resin. As a result, the mechanical strength of the fiber reinforced resin may be impaired.

Preferably, the pressure vessel is configured to store hydrogen gas therein. Also preferably, the pressure vessel is configured to be mounted in a motor vehicle.

Another embodiment of the present invention provides a method of manufacturing a pressure vessel, comprising: dispersing nylon particles in molten thermosetting resin; impregnating reinforcing fibers with the molten thermosetting resin having the nylon particles dispersed therein; wrapping the reinforcing fibers impregnated with the molten thermosetting resin around a mandrel; heating the reinforcing fibers and the thermosetting resin to cure the thermosetting resin; and removing the mandrel from the thermosetting resin after curing the thermosetting resin.

Thereby, simply by adding the step of dispersing the nylon particles in the molten thermosetting resin, the pressure vessel can be given with the required gas barrier property so that the manufacturing cost can be minimized, and the work efficiency can be maintained.

According to yet another embodiment of the present invention, there is provided a method of manufacturing a pressure vessel, comprising: preparing tow prepreg containing reinforcing fibers impregnated with thermosetting resin having nylon particles dispersed therein; wrapping the tow prepreg around a mandrel; heating the tow prepreg and the thermosetting resin to cure the thermosetting resin; and removing the mandrel from the thermosetting resin after curing the thermosetting resin.

By thus using the tow prepreg or a narrow strip of prepreg tape or ribbon made of fine reinforcing fibers, a pressure vessel having a particularly favorable property can be manufactured. Again, the manufacturing cost can be minimized, and the work efficiency can be maintained.

The present invention thus provides a pressure vessel for storing pressurized gas such as hydrogen gas, CNG (compressed natural gas) and LPG (liquefied petroleum gas) that has a high gas barrier property and is simple in structure, and a method of manufacturing such a pressure vessel.

### BRIEF DESCRIPTION OF THE DRAWING(S)

FIG. 1 is a perspective view of a pressure vessel according to an embodiment of the present invention;

FIG. 2 is a sectional view of the pressure vessel;

FIG. 3 is an enlarged sectional view of the wall of the pressure vessel;

FIG. 4 is a view illustrating a first manufacturing process for the pressure vessel;

FIG. 5 is a view illustrating a second manufacturing process for the pressure vessel;

FIG. 6 is a photographic image of a cross section of the wall of the pressure vessel; and

FIG. 7 is a graph showing the relationship between the nylon particle content and the hydrogen permeability coefficient in the fiber reinforced resin forming the pressure vessel.

### DESCRIPTION OF THE PREFERRED EMBODIMENT(S)

A pressure vessel according to an embodiment of the present invention, along with the manufacturing methods therefor, is described in the following with reference to the appended drawings.

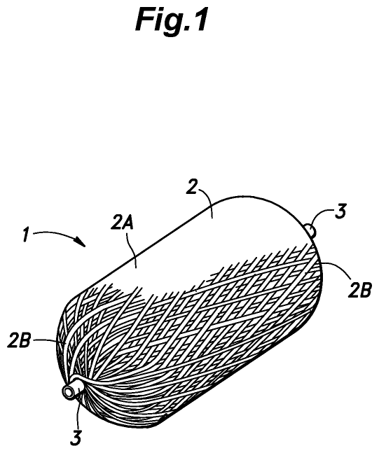

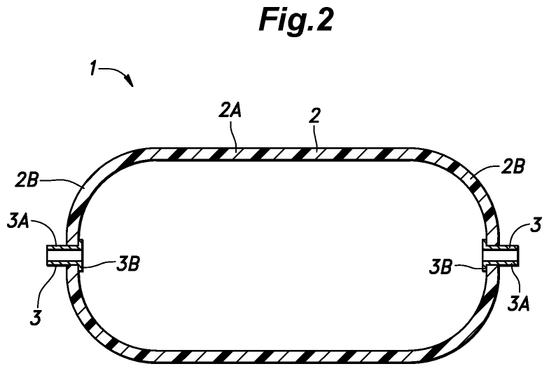

As shown in FIGS. 1 and 2, the pressure vessel 1 has a tank body 2, and a pair of caps 3 provided at either axial end of the tank body 2. The tank body 2 has a cylindrical main body 2A and a pair of hemispherical end portions 2B that close the respective axial ends of the main body 2A. Each cap 3 has a tube portion 3A and a flange 3B provided at the inner axial end of the tube portion 3A. The caps 3 are each centrally inserted in the corresponding axial end portion 2B of the tank body 2 such that the flange 3B is attached to or embedded in the wall of the hemispherical end portion 2B of the tank body 2, and the other end of the tube portion 3A project out of the hemispherical end portion 2B of the tank body 2. Thus, the caps 3 are securely attached to the pressure vessel 1, and communicates the interior of the pressure vessel 1 with the outside via a bore defined in the tube portion 3A of each cap 3. Typically, a sealing plug is fitted into one of the caps 3, and a valve or tubing is connected to the other cap 3 when in use.

The pressure vessel 1 of the illustrated embodiment is designed for storing hydrogen gas, CNG (compressed natural gas), LPG (liquefied petroleum gas), or the like. In particular, the pressure vessel 1 is suitable for use as a tank mounted in a motor vehicle.

The tank body 2 is made of fiber reinforced resin. The fiber reinforced resin contains reinforcing fibers, a thermosetting resin impregnated in the reinforcing fibers, and nylon particles contained in the thermosetting resin. The thermosetting resin is cured by a suitable heat treatment.

The reinforcing fibers may include, not exclusively, carbon fibers, glass fibers, aramid fibers, boron fibers, or mixtures of these fibers. The reinforcing fibers are preferably continuous fibers, and the fibers are aligned to form a bundle. The diameter of the reinforcing fibers is preferably 5 μm to 10 μm, for example. The reinforcing fibers may consist of carbon fibers having a density of 1.6 to 1.7 g/cm³, or glass fibers having a density of 2.5 to 2.7 g/cm³.

The thermosetting resin forms the matrix for the fiber reinforced resin. The thermosetting resin may consist of, not exclusively, an epoxy resin, a phenol resin, an unsaturated polyester, or the like.

Nylon particles are particles formed from nylon. Nylon includes, for example, at least one of nylon 6, nylon 11, nylon 12, nylon 6,6, and nylon 4,6. The nylon particles contained in the cured thermosetting resin preferably has a diameter in the range of 5 μm to 30 μm. In particular, when the diameter of the reinforcing fibers is 5 μm to 10 μm, the diameter of the nylon particles is preferably 5 μm to 30 μm. The ratio of the nylon particles to the thermosetting resin is preferably 2 to 20% by weight. Nylon has a functional group having an affinity with a thermosetting resin such as an epoxy resin.

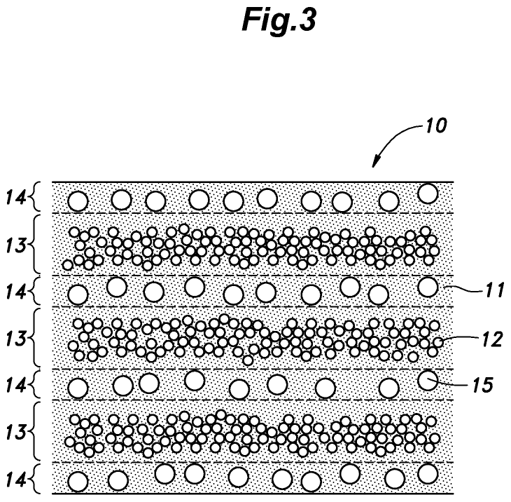

As shown in FIG. 3, the fiber reinforced resin 10 forming the tank body 2 includes reinforcing fiber layers 13 each containing more of the reinforcing fibers 12 than the thermosetting resin 11 in volume, and matrix layers 14 containing more of the thermosetting resin 11 than the reinforcing fibers 12 in volume which are laminated one over the other in an alternating manner. In each reinforcing fiber layer 13, the reinforcing fibers 12 form bundles in which the reinforcing fibers 12 extend in parallel to one another. The nylon particles 15 are included in the thermosetting resin 11 such that the nylon particles 15 are more abundantly present in the matrix layers 14 than in the reinforcing fiber layers 13. In other words, the nylon particles 15 are predominantly distributed in the matrix layers 14, and are only thinly distributed in the reinforcing fiber layers 13. By thus distributing the nylon particles 15 unevenly in the wall of the pressure vessel 1, relatively dense layers of nylon particles 15 are formed between the reinforcing fiber layers 13.

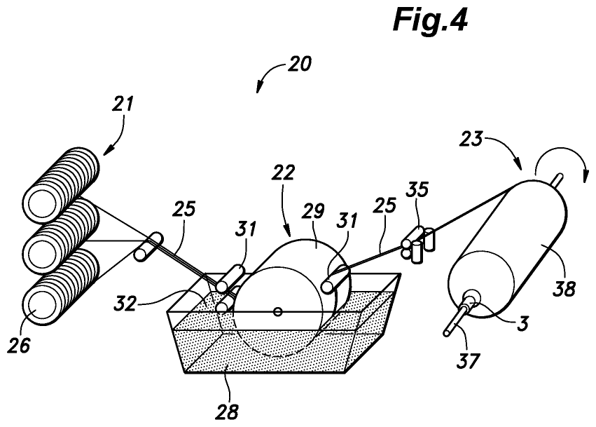

A first method for manufacturing the pressure vessel 1 is described in the following with reference to FIG. 4. This method is essentially based on the per se known filament winding method.

As shown in FIG. 4, a first manufacturing device 20 according to an embodiment of present invention includes a yarn feeding unit 21, an impregnating unit 22 (resin bath), and a forming unit 23 (filament winder).

The yarn feeding unit 21 supplies a reinforcing fiber bundle 25 (or yarns) containing a plurality of reinforcing fibers aligned in parallel with each other. The yarn feeding unit 21 has a crill containing a plurality of bobbins 26 around which reinforcing fibers are wound, and the reinforcing fibers supplied from the bobbins 26 are aligned to form the reinforcing fiber bundle 25. The yarn feeding unit 21 may have a tension control unit that controls the tension of the reinforcing fiber bundle 25.

The impregnating unit 22 includes a tank 28, an impregnating roller 29 provided on the upper part of the tank 28, and a plurality of guide rollers 31. The tank 28 stores a resin mixture 32 consisting of molten thermosetting resin and nylon particles suspended therein. The reinforcing fiber bundle 25 supplied from the yarn feeding unit 21 passes through the resin mixture 32 stored in the tank 28 by passing under the impregnating roller 29. By thus passing the reinforcing fiber bundle 25 through the resin mixture 32, the reinforcing fiber bundle 25 is impregnated with the thermosetting resin containing the nylon particles. In other words, the molten thermosetting resin containing nylon particles adheres to the reinforcing fiber bundle 25.

The forming unit 23 includes a supply unit 35 that feed out the reinforcing fiber bundle 25 impregnated with the thermosetting resin, and a support shaft 37 supported by a movable arm (not shown). The support shaft 37 supports a mandrel 38 for forming the inner surface of the tank body 2, and a pair of caps 3 to be incorporated in the pressure vessel 1 on the outer periphery thereof. The supply unit 35 defines a passage through which the reinforcing fiber bundle 25 that has passed through the impregnating unit 22 is conducted. The supply unit 35 may define a passage for the reinforcing fiber bundle 25, for example, by a plurality of rollers. The supply unit 35 serves as a relay unit for the reinforcing fiber bundle 25 supplied from the impregnating unit 22 to the mandrel 38, and is supported by a movable mechanism (not shown in the drawings) so that the reinforcing fiber bundle 25 may be supplied to the mandrel 38 at the prescribed position and at the prescribed angle. More specifically, the support shaft 37 is supported by a movable arm so as to be tiltable and rotatable.

The first manufacturing method includes a step of suspending nylon particles in a molten thermosetting resin (first step), a step of impregnating a reinforcing fiber bundle with the thermosetting resin containing the nylon particles suspended therein (second step), a step of winding the reinforcing fiber bundle impregnated with the thermosetting resin around a mandrel 38 (third step), a step of heating the reinforcing fiber bundle wound around the mandrel 38 and the thermosetting resin to cure the thermosetting resin (fourth step), and a step of removing the mandrel 38 from the thermosetting resin after the thermosetting resin is cured (fifth step). The reinforcing fibers, the thermosetting resin, and nylon particles used in the first manufacturing method may be made of the materials discussed above.

In the first step of the first manufacturing method, the molten thermosetting resin is stored in the tank 28 of the impregnating unit 22, and nylon powder is added to the thermosetting resin and mixed therewith. The nylon powder to be added preferably has a particle diameter of 5 μm to 30 μm. The nylon powder does not dissolve in the molten thermosetting resin, but is dispersed as nylon particles and is suspended in the thermosetting resin. Thereby, the resin mixture 32 containing the molten thermosetting resin and the nylon particles suspended or dispersed therein is prepared. The molten thermosetting resin and nylon powder may be mixed in advance in a separate container before being introduced into the tank 28.

In the second step of the first manufacturing method, a plurality of reinforcing fibers are pulled out from the yarn feeding unit 21 to form a reinforcing fiber bundle 25, and the reinforcing fiber bundle 25 is passed through the resin mixture 32 in the tank 28 of the impregnating unit 22. The reinforcing fiber bundle 25 is thus impregnated with the thermosetting resin containing the nylon particles. Thereby, the thermosetting resin containing the nylon particles adheres to the reinforcing fiber bundle 25, and the reinforcing fiber bundle 25 is covered with the thermosetting resin containing the nylon particles.

In the third step of the first manufacturing method, the reinforcing fiber bundle 25 impregnated with the thermosetting resin containing the nylon particles is wound around the outer periphery of the mandrel 38 and the caps 3 in the forming unit 23, and the tank body 2 is formed into the prescribed shape. The reinforcing fiber bundle 25 is supplied from the impregnating unit 22 to the outer periphery of the mandrel 38 through the supply unit 35. The forming unit 23 controls the angle and the position of the supply unit 35 to control the supply angle and the supply position of the reinforcing fiber bundle 25 to the mandrel 38. Moreover, the forming unit 23 controls the winding angle and the winding amount of the reinforcing fiber bundle 25 to the mandrel 38 by controlling the angle and the rotation of an arm. The reinforcing fiber bundle 25 is wound around various parts of the surface of the mandrel 38 a plurality of times so as to form a plurality of layers in the thickness direction of the tank body 2.

In the fourth step of the first manufacturing method, the reinforcing fiber bundle 25 wound around the mandrel 38 and the caps 3 and impregnated with the thermosetting resin containing the nylon particles is heated to cure the thermosetting resin. The heating temperature may be selected according to the curing temperature of the selected thermosetting resin material. By curing the thermosetting resin, the tank body 2 having a prescribed shape is formed. The caps 3 are fixedly secured to the respective end portions of the tank body 2 in a highly gas-tight manner.

In the fifth step of the first manufacturing method, the support shaft 37 is pulled out from the mandrel 38 and the caps 3, and a solvent for dissolving the mandrel 38 is supplied into the tank body 2 through the caps 3. Thereby, the mandrel 38 is dissolved by the solvent inside the tank body 2. The dissolved mandrel 38 is discharged to the outside of the tank body 2 through the caps 3. The solvent may be selected according to the material of the mandrel 38. For example, when the mandrel 38 is water-soluble, the solvent may be water. By removing the mandrel 38, the pressure vessel 1 having the tank body 2 and the caps 3 is formed.

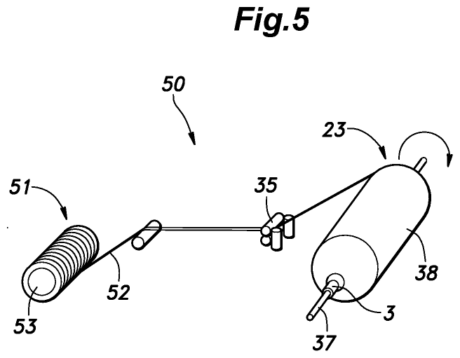

In a second manufacturing method, a second manufacturing device 50 shown in FIG. 5 is used. The second manufacturing device 50 includes a tow prepreg feed unit 51 and a forming unit 23. Since the forming unit 23 of the second manufacturing device 50 has the same configuration as the forming unit 23 of the first manufacturing device 20, the description thereof is omitted.

The tow prepreg feed unit 51 supplies to the forming unit 23 a tow prepreg 52 consisting of a reinforcing fiber bundle or a reinforcing fiber tape impregnated with a thermosetting resin containing nylon particles. The tow prepreg 52 is obtained by impregnating a reinforcing fiber bundle composed of a plurality of reinforcing fibers with a thermosetting resin containing nylon particles, and heating or drying the thermosetting resin into a semi-cured state. The tow prepreg 52 has a structure in which the semi-cured thermosetting resin is attached to the reinforcing fiber bundle, and has a certain flexibility. The tow prepreg 52 is formed in a continuous bundle shape (tape or ribbon). The tow prepreg 52 is typically available in a state where the tow prepreg 52 is wound around a bobbin.

The second manufacturing method includes a step of preparing a tow prepreg 52 in which a reinforcing fiber bundle is impregnated with a thermosetting resin containing nylon particles (first step), a step of winding the tow prepreg 52 around a mandrel 38 (second step), a step of heating the tow prepreg 52 wound around the mandrel 38 to cure the thermosetting resin (third step), and removing the mandrel 38 from the thermosetting resin after the thermosetting resin is cured (fourth step). The reinforcing fibers, the thermosetting resin, and the nylon particles used in the second manufacturing method may be made of the materials discussed above.

In the first step of the second manufacturing method, the nylon powder is mixed with the molten thermosetting resin to prepare the resin mixture in which the nylon particles are suspended in the thermosetting resin. Subsequently, the resin mixture is impregnated into the reinforcing fiber bundle, in which the reinforcing fibers are aligned, to cause the resin mixture to adhere to the reinforcing fiber bundle. Subsequently, the tow prepreg 52 having a certain flexibility is obtained by heating or drying the thermosetting resin to place the thermosetting resin adhering to the reinforcing fiber bundle into a semi-cured state.

In the second step of the second manufacturing method, the tow prepreg 52 supplied from the tow prepreg feed unit 51 is wound around the outer periphery of the mandrel 38 and the caps 3 in the forming unit 23, and formed into the shape of the tank body 2. The tow prepreg 52 is supplied from the tow prepreg feed unit 51 to the outer periphery of the mandrel 38 via the supply unit 35. The forming unit 23 controls the angle and the position of the supply unit 35 to control the supply angle and the supply position of the tow prepreg 52 to the mandrel 38. Further, the forming unit 23 controls the winding angle and the winding amount of the tow prepreg 52 around the mandrel 38 by controlling the angle and rotation of the arm. The tow prepreg 52 is wound around the surface of the mandrel 38 a plurality of times, and forms a plurality of layers in the thickness direction of the tank body 2.

In the third step of the second manufacturing method, the tow prepreg 52 wound around the mandrel 38 and the caps 3 are heated to cure the thermosetting resin. The heating temperature may be selected according to the curing temperature of the selected thermosetting resin material. By curing the thermosetting resin, the tank body 2 having a prescribed shape is formed. The caps 3 are fixedly secured to the respective ends of the tank body 2 in a highly air-tight manner.

The fourth step of the second manufacturing method is the same as the fifth step of the first manufacturing method. The mandrel 38 is removed from the tank body 2 cured in the third step of the second manufacturing method, and the pressure vessel 1 having the tank body 2 and the caps 3 is formed.

The pressure vessel 1 configured as described above can improve the gas barrier property of the pressure vessel 1 because the nylon particles having a favorable gas barrier property are present in the thermosetting resin. When the thermosetting resin is epoxy, since nylon has a higher gas barrier property than epoxy resin with respect to such gases as hydrogen, CNG, and LPG, the gas barrier property of the matrix of the fiber reinforced resin made of epoxy resin can be improved. Nylon also inhibits the molecular motion of the thermosetting resin such as epoxy resin, and inhibits activated diffusion flow of hydrogen molecules in the thermosetting resin. Owing to this action, the gas barrier property of the fiber reinforced resin can be improved. Nylon particles can improve the gas barrier property of the pressure vessel 1 with respect to various gases such as hydrogen gas, CNG and LPG.

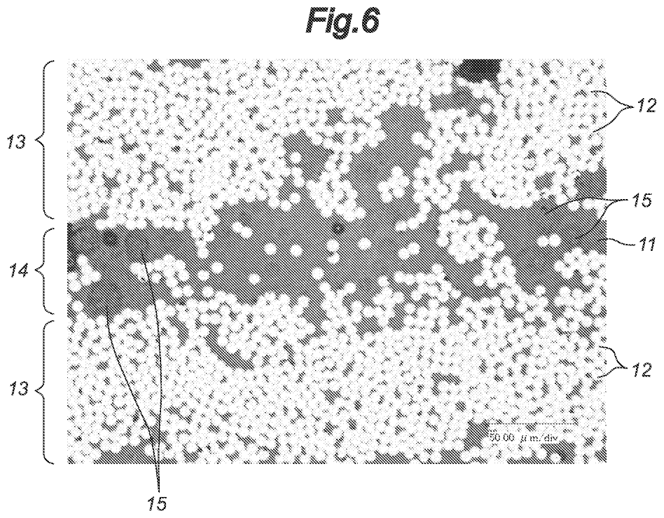

FIG. 6 shows a cross sectional microscopic image of the wall of the tank body 2 made of a fiber reinforced resin in which the reinforcing fibers 12 consist of carbon fibers, the thermosetting resin 11 consists of epoxy resin, and the nylon particles 15 consist of nylon 6,6. As shown in FIG. 6, the nylon particles 15 are present in the form of particles in the thermosetting resin 11 without being dissolved in the thermosetting resin 11. Since the nylon particles 15 are uniformly contained in the thermosetting resin 11, the nylon particles 15 exist more in the matrix layer 14 than in the reinforcing fiber layer 13. Thereby, the nylon particles 15 are disposed as layers located between the laminated reinforcing fiber layers 13. Nylon particles 15 are more densely distributed in the matrix layers 14 than in the reinforcing fiber layers 13, and therefore form layers between the adjoining reinforcing fiber layers 13.

By selecting the diameter of the nylon particles to be 5 μm to 30 μm, the nylon particles are prevented from entering the gaps between the reinforcing fibers 12 which have a diameter of 5 μm to 10 μm, and a large part of the nylon particles are distributed in the matrix layer 14. If the diameter of the nylon particles is smaller than 5 μm, the nylon particles tend to be actively dispersed between the reinforcing fibers 12 so that no well-defined nylon particle layers are likely to be formed.

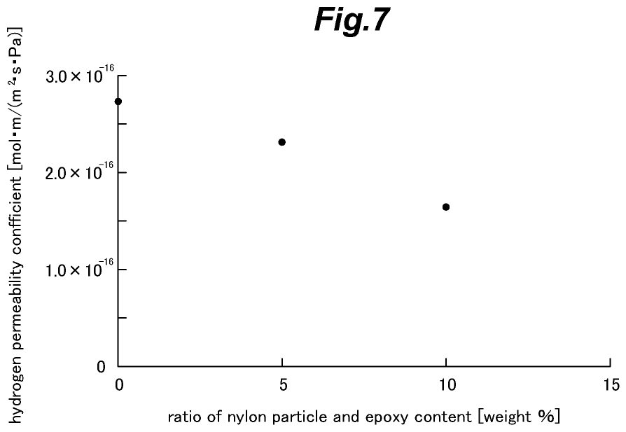

FIG. 7 is a graph showing the relationship between the nylon particle content and the hydrogen permeability coefficient in the fiber reinforced resin forming the tank body 2. The hydrogen permeability coefficient is a value measured when the temperature of the fiber reinforced resin is 23° C. The fiber reinforced resin forming the tank body 2 was prepared by using carbon fibers as the reinforcing fibers, epoxy resin as the thermosetting resin, and nylon 6, 6 as the nylon particles.

As shown in FIG. 7, the hydrogen permeability coefficient decreased as the content of nylon particles increased. It was confirmed that when the weight percentage of the nylon particles relative to the thermosetting resin is 10%, the hydrogen permeability coefficient is reduced by 40% as compared to the case where the weight percentage of the nylon particles is 0%. From this result, it can be seen that an adequate gas barrier property can be achieved by selecting the ratio of the nylon particles to the thermosetting resin to be 2% to 20% by weight when the wall thickness of the tank body 2 is 10 mm to 40 mm, the temperature of the tank body 2 is −50° C. to 80° C., and the hydrogen pressure in the pressure vessel 1 is 70 MPa. If the ratio of the content of the nylon particles to the content of the thermosetting resin is greater than 20% by weight, the viscosity of the thermosetting resin containing the nylon particles increases to such an extent that internal faults are more likely to occur, and the moldability of the thermoplastic resin is impaired. As a result, the mechanical strength of the fiber reinforced resin is reduced.

Since the nylon particles can be kept dispersed in the thermosetting resin simply by mixing the nylon particles with the molten thermosetting resin, the gas barrier property of the pressure vessel 1 can be improved without complicating the structure of the pressure vessel 1, or the manufacturing process of the pressure vessel.

The present invention has been described in terms of a specific embodiment, but the present invention is not limited by such an embodiment, and can be modified in various ways without departing from the spirit of the present invention.

1. A pressure vessel formed by a fiber reinforced resin including reinforcing fibers and thermosetting resin impregnated in the reinforcing fibers,
wherein the fiber reinforced resin comprises nylon particles dispersed in the thermosetting resin.

2. The pressure vessel according to claim 1, wherein the nylon particles have a diameter of 5 μm to 30 μm.

3. The pressure vessel according to claim 1, wherein the nylon particles are contained in the thermosetting resin by 2 to 20 weight %.

4. The pressure vessel according to claim 1, wherein the pressure vessel is configured to store hydrogen gas therein.

5. The pressure vessel according to claim 1, wherein the pressure vessel is configured to be mounted in a motor vehicle.

6. A method of manufacturing a pressure vessel, comprising:
dispersing nylon particles in molten thermosetting resin;
impregnating reinforcing fibers with the molten thermosetting resin having the nylon particles dispersed therein;
wrapping the reinforcing fibers impregnated with the molten thermosetting resin around a mandrel;
heating the reinforcing fibers and the thermosetting resin to cure the thermosetting resin; and
removing the mandrel from the thermosetting resin after curing the thermosetting resin.

7. A method of manufacturing a pressure vessel, comprising:
preparing tow prepreg containing reinforcing fibers impregnated with thermosetting resin having nylon particles dispersed therein;
wrapping the tow prepreg around a mandrel;
heating the tow prepreg and the thermosetting resin to cure the thermosetting resin; and
removing the mandrel from the thermosetting resin after curing the thermosetting resin.
